(19) United States
(12) Patent Application Publication
(10) Pub. No.: US 2014/0180640 A1
(43) Pub. Date: Jun. 26, 2014

(54) SENSOR ARRANGEMENT AND PROCESS WITH NOTCH FILTER IN SIGNAL PROCESSING

(71) Applicant: GM GLOBAL TECHNOLOGY OPERATIONS LLC, Detroit, MI (US)

(72) Inventors: MARCUS ANDRÉ REUL, NAUHEIM (DE); FRANK BONARENS, OBERURSEL (DE)

(73) Assignee: GM GLOBAL TECHNOLOGY OPERATIONS LLC, Detroit, MI (US)

(21) Appl. No.: 14/084,318

(22) Filed: Nov. 19, 2013

(30) Foreign Application Priority Data
Nov. 21, 2012 (DE) 102012022702.7

(51) Int. Cl. G01P 15/00

(52) U.S. Cl. CPC G01P 15/00
USPC 702/190

(57) ABSTRACT

The invention concerns a sensor arrangement having at least one condition parameter sensor, one sensor connection structure for the connection of the at least one condition parameter sensor to a structural construction element as well as with one of the signal processing devices which are coupled to the at least one condition parameter sensor, which includes a frequency elimination filter for an averaging of the signal of the at least one condition parameter sensor over the cycle duration of the first natural frequency of the sensor arrangement. This creates the possibility of creating a notch filter with a notch frequency, which corresponds to the first natural frequency of the acceleration sensor arrangement and exhibits a high filter quality. The notch frequency and the whole number multiples are thereby fully eliminated and disturbances due to the natural frequencies of the sensor arrangement are avoided.

The invention concerns a sensor arrangement comprising at least one condition parameter sensor, one sensor connection structure for the connection of at least one condition parameter sensor to a structural construction element as well as one signal processing device that is coupled with the at least one condition parameter sensor, which includes a filter unit for the signal of the at least one condition parameter sensor. The invention furthermore concerns a process for the digital filtration of the signal of at least one condition parameter sensor in a sensor arrangement with a sensor connection structure for the attachment of the at least one condition parameter sensor to a structural construction element, by means of a filter unit.

Up until today, when dealing with the attachment of condition parameter sensors, in particular in the case of acceleration sensors fitted by means of sensor connection structures to structural construction elements, in particular in the cases of automobiles and aircraft, one required a possibly rigid connection, so as to ensure that the first natural frequency coming from a sensor arrangement made up of sensors, a sensor mount and housing elements was situated above the largest natural frequency of sensor elements themselves. This is typically the case above approximately 150 Hz. Natural oscillations of the sensor system thereby do not appear as disturbances in the signals that are achieved by means of sensor elements. A rigid sensor attachment does however require a rigid and thereby heavy attachment structure, or alternatively attachment fixtures, which is increasingly contrary to weight reduction and packaging requirements.

It would be desirable to develop a sensor arrangement, whose first natural frequency would be situated below the greatest natural frequency of the sensor elements, which would allow one to use sensor connection structures requiring less rigidity and a lesser weight.

From DE 10 2007 011 816 A1 it is in itself taught to provide a filter device in the signal processing device that is connected with the sensor elements, which can also be laid out as a notch filter, whereby it appears to be possible to damper critical frequencies, therefore, in particular, the first natural frequency of the acceleration sensor. The traditional notch filters do indeed demonstrate significant possible damping, however a complete elimination of the notch frequency is either not possible or structurally very complex or it leads to major dead times or alternatively group delays.

The object of the invention is therefore that of providing a sensor arrangement with at least one condition parameter sensor or alternatively a process for the digital signal filtering of the signal of at least one condition parameter sensor, which will then also allow for the operation or alternatively for the measurement to be undisturbed as much as possible when the attachment of the sensor arrangement to the structural construction element only features a limited rigidity or alternatively a limited weight, or when due to other causes, the first natural frequency of the sensor arrangement is situated below the first natural frequency of the sensor elements.

The solution to this purpose can be deduced from the features of Claims 1 and 10. Advantageous further development and refinements are the object of the dependent Claims. Further features, application possibilities and advantages of the invention result from the following description as well as the explanations of the embodiments of the invention which are represented in the Figures.

In particular, in accordance with the device, the object is thereby solved that in the case of a sensor arrangement having at least one condition parameter sensor, a sensor connection structure used for the connection of the at least one condition parameter sensor to a structural construction element as well as to the signal processing device which is coupled with the at least one condition parameter sensor, which includes a filter unit for the signal of the at least one condition parameter sensor, the filter unit is set out as a frequency elimination filter for an averaging of the signal of the at least one condition parameter sensor over the time span of the first natural frequency of the sensor arrangement.

Furthermore, the purpose is solved through a process for the digital signal filtration of the signal of at least one condition parameter sensor in a sensor arrangement having a sensor connection structure for the attachment of the at least one condition parameter sensor to one structural construction element, through which an averaging of the signal of the at least one condition parameter sensor takes place over the cycle duration of the first natural frequency of the sensor arrangement.

These features according to the invention enable the formation of a notch filter having a notch frequency that corresponds to the first natural frequency of the acceleration sensor arrangement and features a high filter quality. The notch frequency and the whole number multiples thereof are thus completely eliminated and thereby disturbances brought about by the natural frequencies of the sensor arrangement from the sensor frequency response and with it the sensor signal are avoided. It is thus possible that a flexible and economical connection of sensor systems is possible even in the case of connections that exhibit limited rigidity. This in turn leads to weight and cost savings. Furthermore, when compared to traditional filter technology, only a minimum signal delay occurs, which is to say a minimum group delay. Significant signal attenuation can nonetheless be achieved in the proximity of the notch frequency, which leads to a greater robustness in terms of variations of natural frequency.

When speaking of a condition parameter sensor, one understands all sensors that include state variables that are subject to vibration-induced disturbances. In particular, it refers to acceleration sensors; however, one can also understand other sensors such as temperature or pressure sensors.

When speaking of a sensor connection structure, one could for example, understand a sensor holder or also a structural construction element, which, due to limited rigidity, are sensitive to vibration, for example, in the case of the thin lateral body panels of an automobile.

When speaking of natural frequency, one should understand both the undamped natural frequency of a vibration system as well as the damped natural frequency (resonance frequency).

When speaking of averaging, one is to understand both a periodic as well as also a non-periodic (stochastic) averaging.

When speaking of a frequency elimination filter, one should preferably understand a notch filter.

In accordance with an advantageous further development of the invention, the sensor arrangement includes multiple acceleration sensors, which are sensitive in various axial directions, for the capture of multi-axial accelerations. It is thereby also possible to correspondingly equip multi-axial sensor arrangements. In this case, a separate frequency elimination filter takes precedence over each acceleration sensor, so that the individual acceleration signals may be used individually in the axial directions.

In accordance with an advantageous further development of the invention, the number of averaging values is modifiable. Alternatively or additionally, in accordance with a further advantageous development of the invention, the measurement update rate is modifiable. A speedy or alternatively uncomplicated adjustment to modified data or circumstances is thereby possible, for example, a natural frequency that is modified through external circumstances. Furthermore, the notch filter according to the invention, with limited effort, for example by software, can be adjusted to distinct sensor arrangements having distinct natural frequencies.

A preferred application of the sensor arrangement is in an automobile, wherein an ever more wide-ranging multi-axial sensor technology is needed for modern automobile management systems. When speaking of an automobile, one is to understand all single or multi-track vehicles, irrespective of the drive technology that is used. The invention can be applied in the same manner to aircraft or sea craft.

Further advantages, features and details can be deduced from the following description in which one embodiment is described in detail with reference to the drawing. Identical, similar and/or functionally equivalent parts are indicated with the same references.

The Figures show the following:

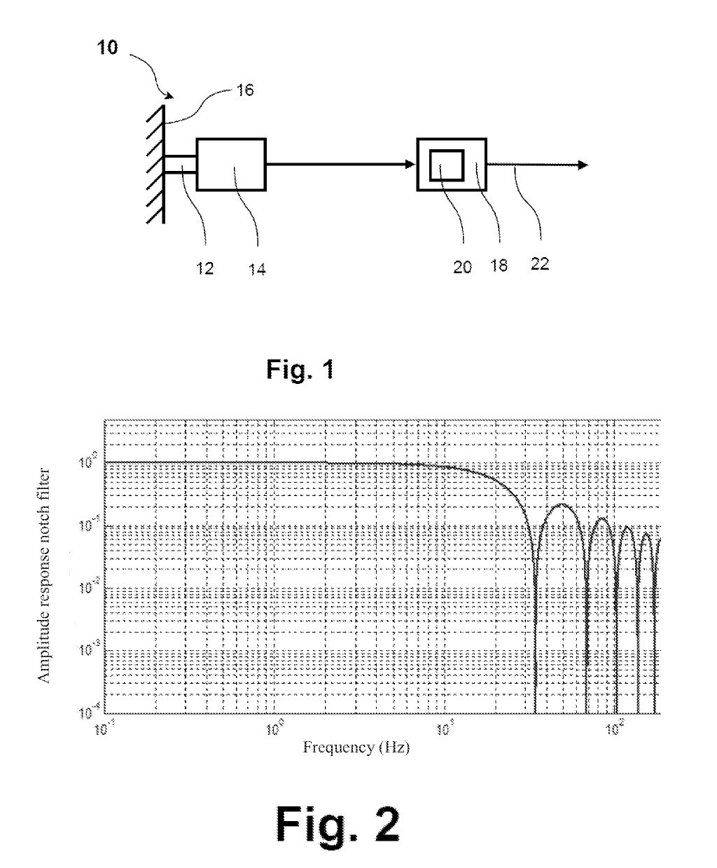

FIG. 1 a schematic block diagram of an acceleration sensor arrangement;

FIG. 2 a frequency response representation of the notch filter.

FIG. 1 shows an acceleration sensor arrangement 10, including a sensor holder 12 for the attachment of a sensor assembly 14 that comprises one, however preferably more, acceleration sensor that is sensitive in multiple axes, on a structural construction element 16. In the case of the structural construction element 16, one could preferably be dealing with the bodywork of an automobile or the fuselage of an aircraft. The sensor assembly 14 is coupled with a signal processing device 18, which serves the purpose of providing energy to the acceleration sensors (inasmuch as it is necessary) as well as for the digital processing of the acceleration signals coming from the acceleration sensors.

A notch filter 20 is a component of the signal processing device 18, which is traversed by the signal of an acceleration sensor, whereby the notch filter 20 which features the characteristic represented in FIG. 2, therefore eliminates the notch frequency, which is 35 Hz in the illustrated example, as well as whole number multiples of the notch frequency. The natural frequencies of the acceleration sensor arrangement 10 are therefore completely removed from the output signal 22 of the acceleration sensor arrangement 10. Insofar as the sensor assembly 14 comprises multiple acceleration sensors, the signals of which are naturally fed individually to the signal processing device 18, a preferably identically constructed notch filter 20 is individually foreseen for every signal path.

In this embodiment, the notch filter 20 functions as follows: a floating averaging of the signals of the acceleration sensors is undertaken over the cycle duration of the first natural frequency of the acceleration sensor arrangement. Let us say that the first natural frequency of the acceleration sensor arrangement were to be 35 Hz, which is to say, the cycle duration corresponds to 29 ms (=1/35 Hz). Let us furthermore say that there is an update rate of the signal acquisition of 1 ms (this can be freely configured, it is only necessary that buffer storage in the signal processing device 18 be correspondingly dimensioned for the storage of all the stored values). In the embodiment at hand, there is therefore a floating averaging of the last 29 measurement values. The result is the frequency response represented in FIG. 2, in which the natural frequencies of the acceleration sensor arrangement that began at the first natural frequency of 35 Hz have been filtered out. Furthermore it is significant that a group delay of 29 ms/2, which is to say, approximately 15 ms, is achievable, which moreover is constant over the frequency. The envelope of the notch filter frequency response is a PT₁. behavior.

Notwithstanding that the invention is more closely illustrated and described in detail through preferred embodiments, it is nonetheless not limited by the disclosed examples and other variants can be deduced by the person skilled in the art, without straying from the scope of protection of the invention. It is therefore clear that a multitude of possible variants exist. It is likewise clear that the embodiments that have been named as examples actually only represent examples, which are not in any way to be deemed as being limitations as regards the scope of protection, the application possibilities or the configuration of the invention. On the contrary, the description and the drawing description place the person skilled in the art in the position to concretely implement the representative embodiments, whereby the person skilled in the art, with the knowledge of the disclosed invention teaching, will be able to undertake various changes, for example, as regards the function or the arrangement of individual elements that are named in an exemplary embodiment, without straying from the scope of protection of the invention defined by the Claims and their legal equivalents, as might be defined in a further explanation in the description.

1. A sensor arrangement comprising at least one condition parameter sensor, one sensor connection structure for connection of the at least one condition parameter sensor to a structural construction element and at least one signal processing device which are coupled with the at least one condition parameter sensor, that includes a filter unit for signals of the at least one condition parameter sensor, whereby the filter unit is set up as a frequency elimination filter for averaging of the signals of the at least one condition parameter sensor over a cycle duration of the first natural frequency of the sensor arrangement.

2. The sensor arrangement according to claim 1, wherein the at least one condition parameter sensor is an acceleration sensor, a temperature sensor or a pressure sensor.

3. The sensor arrangement according to claim 2, wherein the at least one parameter sensor includes a plurality of acceleration sensors that are sensitive in different axial directions for collection of multi-axial accelerations.

4. The sensor arrangement according to claim 1, wherein the averaging is a floating averaging.

5. The sensor arrangement according to claim 4, wherein a number of measurement values that are considered in the floating averaging are determined by the cycle duration multiplied by a measurement update rate.

6. The sensor arrangement according to claim 5, wherein the number of averaging measurement values are modifiable.

7. The sensor arrangement according to claim 5, wherein the measurement value update rate is modifiable.

8. The sensor arrangement according to claim 1, wherein the sensor arrangement is on an automobile.

9. The sensor arrangement according to claim 1, wherein the sensor arrangement is on an aircraft or a sea craft.

10. A process for digital signal filtration of a signal from at least one condition parameter sensor in a sensor arrangement having one sensor connection structure for the attachment of the at least one condition parameter sensor to a structural construction element, by means of a filter unit, whereby an averaging of the signal of the at least one condition parameter sensor is undertaken using a cycle duration of the first natural frequency of the sensor arrangement.

11. The process according to claim 10, wherein the averaging is a floating averaging.

12. The process according to claim 11, wherein a number of averaging measurement values to be considered in the floating averaging is determined by the cycle duration multiplied by a measurement value update rate.

13. The process according to claim 12, wherein the number of averaging measurement values are modifiable.

14. The process according to claim 12, wherein the measurement value update rate is modifiable.
